(19) United States
(12) Patent Application Publication
(10) Pub. No.: US 2025/0303259 A1
(43) Pub. Date: Oct. 2, 2025

(54) INFORMATION PROCESSING METHOD AND INFORMATION PROCESSING DEVICE

(71) Applicant: SEIKO EPSON CORPORATION, Tokyo (JP)

(72) Inventor: Hideo SASAHARA, SUWA-SHI (JP)

(73) Assignee: SEIKO EPSON CORPORATION, Tokyo (JP)

(21) Appl. No.: 19/090,329

(22) Filed: Mar. 25, 2025

(30) Foreign Application Priority Data
Mar. 26, 2024 (JP) 2024-048959

(51) Int. Cl. A63B 71/06; A63B 24/00

(52) U.S. Cl. CPC A63B 71/0616; A63B 24/0062; A63B 2024/0025; A63B 2071/0691; A63B 2220/12; A63B 2220/31

(57) ABSTRACT

An information processing method includes: receiving first position information and first speed information from a first terminal device configured to acquire the first position information and the first speed information, receiving second position information and second speed information from a second terminal device configured to acquire the second position information and the second speed information, calculating for a course of a competition, participated by a first competitor to which the first terminal device is attached and a second competitor to which the second terminal device is attached, a distance difference between the first competitor and the second competitor, and calculating a speed difference between the first competitor and the second competitor, and issuing a notification related to swapping between a rank of the first competitor and a rank of the second competitor in the competition.

The present application is based on, and claims priority from JP Application Serial Number 2024-048959, filed Mar. 26, 2024, the disclosure of which is hereby incorporated by reference herein in its entirety.

### BACKGROUND

### 1. Technical Field

The present disclosure relates to an information processing method and an information processing device.

### 2. Related Art

In a race information system described in JP-A-2006-271611, a competitor information generation program stored in a storage device of a server calculates a rank based on a sum of distances actually run by competitors of a team up to the current time point, from time and position information acquired by a GPS terminal attached to each of a plurality of competitors, in the team, running a course of respective stages (see JP-A-2006-271611).

However, according to this known technique, rank swapping between a competitor of a certain team and a competitor of another team cannot be predicted, meaning that information related to the rank swapping cannot be presented.

### SUMMARY

An aspect for solving the problem described above is an information processing method including: receiving first position information and first speed information from a first terminal device configured to acquire the first position information and the first speed information based on a signal from a satellite, receiving second position information and second speed information from a second terminal device configured to acquire the second position information and the second speed information based on a signal from the satellite, calculating for a course of a competition, participated by a first competitor to which the first terminal device is attached and a second competitor to which the second terminal device is attached, a distance difference between the first competitor and the second competitor based on the first position information and the second position information, and calculating a speed difference between the first competitor and the second competitor based on the first speed information and the second speed information, and issuing a notification related to swapping between a rank of the first competitor and a rank of the second competitor in the competition, based on the distance difference and the speed difference.

An aspect for solving the problem described above is an information processing device including: a reception unit configured to receive first position information and first speed information from a first terminal device configured to acquire the first position information and the first speed information based on a signal from a satellite, and to receive second position information and second speed information from a second terminal device configured to acquire the second position information and the second speed information based on a signal from the satellite, a storage unit configured to store course information related to a course of a competition, participated by a first competitor to which the first terminal device is attached and a second competitor to which the second terminal device is attached, a determination unit configured to determine a rank of the first competitor and a rank of the second competitor, based on a position of the first competitor and a position of the second competitor, a calculation unit configured to calculate a distance difference between the first competitor and the second competitor based on the first position information and the second position information, and to calculate a speed difference between the first competitor and the second competitor based on the first speed information and the second speed information, and a notification unit configured to issue a notification related to swapping between the rank of the first competitor and the rank of the second competitor, based on the distance difference and the speed difference.

### BRIEF DESCRIPTION OF THE DRAWINGS

FIG. 1 is a diagram illustrating a schematic configuration example including an information processing system including an information processing device according to an embodiment.

FIG. 2 is a diagram illustrating an example of a schematic functional block of a first terminal device according to the embodiment.

FIG. 3 is a diagram illustrating an example of a schematic functional block of the information processing device according to the embodiment.

FIG. 4 is a diagram illustrating an example of information indicating a position of each competitor in a course according to the embodiment.

FIG. 5 is a diagram illustrating an example of speeds of two competitors and an alert notification timing according to the embodiment.

FIG. 6 is a diagram illustrating an example of a relationship between a distance difference and a catch-up time for each average speed difference according to the embodiment.

FIG. 7 is a diagram illustrating an example of a procedure of processing executed in the information processing device according to the embodiment.

### DESCRIPTION OF EMBODIMENTS

An embodiment is described below with reference to the accompanying drawings.

An embodiment will be described.

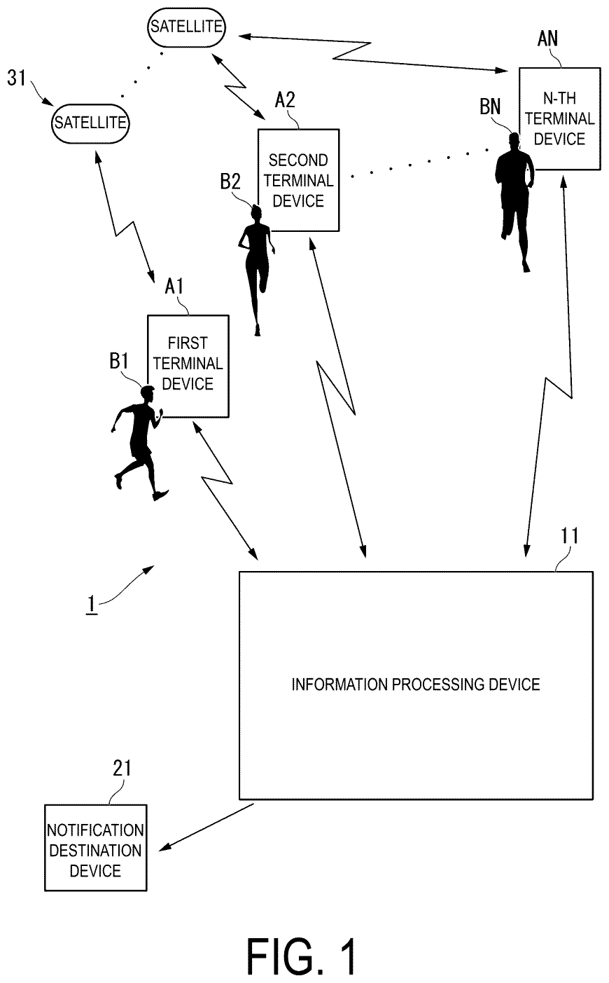

FIG. 1 is a schematic configuration example of an information processing system 1 including an information processing device 11 according to the embodiment.

The information processing system 1 includes an information processing device 11, N, that is, a plurality of terminal devices which are a first terminal device A1 to an N-th terminal device AN, and a notification destination device 21 which is a notification destination.

FIG. 1 further illustrates N, that is, a plurality of competitors who are a first competitor B1 to an N-th competitor BN. Each of the first competitor B1 to the N-th competitor BN is a human being. Each of the first competitor B1 to the N-th competitor BN may be referred to as, for example, an athlete, a user, or the like.

Here, in the present embodiment, in order to simplify the description, it is assumed that other competitors do not participate in the competition participated by the first competitor B1 to the N-th competitor BN. As another example, other participants may participate in the competition. In this case, for example, the processing according to the present embodiment is executed on the first competitor B1 to the N-th competitor BN, and the other competitors are treated as not being present.

In the present embodiment, each of the first competitor B1 to the N-th competitor BN respectively possesses the first terminal device A1 to the N-th terminal device AN. As the possession, for example, terminal devices may be carried by respective competitors, or terminal devices may be attached to a predetermined part of respective competitors. The predetermined part may be any part such as an arm, a leg, the trunk, the head, or the like, for example.

In the present embodiment, the first competitor B1 to the N-th competitor BN are competitors in the same competition.

The competition may be various competitions, and may be, for example, marathon, triathlon, long-distance swimming, or the like.

The competition may be, for example, a competition in which the first competitor B1 to the N-th competitor BN move on a course from a start point to a goal point. The course may be of a long distance, for example.

FIG. 1 illustrates a satellite 31 for a Global Positioning System (GPS).

Although there are a plurality of such satellites, only one satellite 31 is denoted by the reference numeral in the example of FIG. 1 for simplification of illustration.

In general, it is possible to calculate the position and the time by using the positioning mechanism of the GPS. The accuracy of the time is particularly high. Furthermore, with the GPS, it is also possible to calculate the speed and the direction by using the Doppler effect.

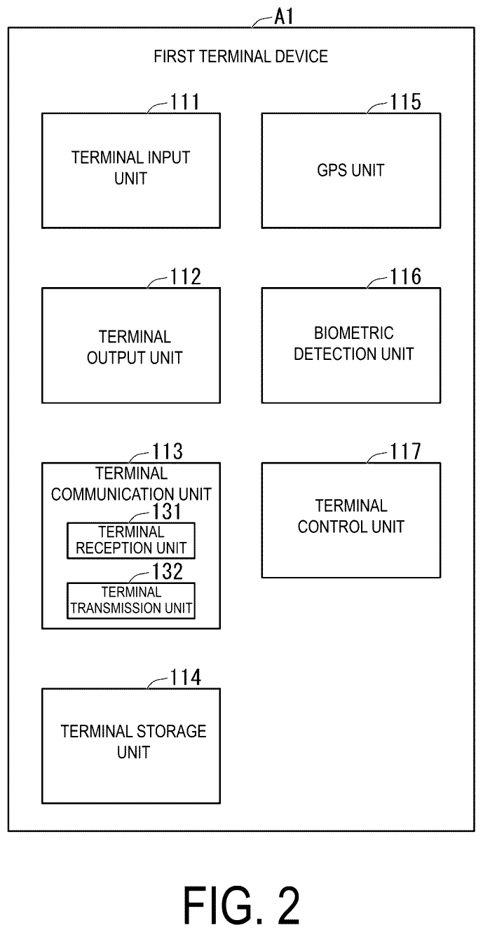

FIG. 2 is a diagram illustrating an example of a schematic functional block of the first terminal device A1 according to the embodiment.

In the case described in the present embodiment, the first terminal device A1 to the N-th terminal device AN have the same configuration and perform the same operation. Therefore, among these, the first terminal device A1 will be representatively described.

As another example, the first terminal device A1 to the N-th terminal device AN may include terminal devices having different configurations and performing different operations.

The first terminal device A1 includes a terminal input unit 111, a terminal output unit 112, a terminal communication unit 113, a terminal storage unit 114, a GPS unit 115, a biometric information detection unit 116, and a terminal control unit 117.

The terminal communication unit 113 includes a terminal reception unit 131 and a terminal transmission unit 132.

Here, in the present embodiment, for convenience of description, a description will be given on a configuration example in which the first terminal device A1 is provided with the biometric information detection unit 116, as well as a case where the function of the biometric information detection unit 116 is not used, and a case where the function of the biometric information detection unit 116 is used.

When the function of the biometric information detection unit 116 is not used, for example, the first terminal device A1 may not be provided with the function of the biometric information detection unit 116.

For example, the terminal input unit 111 has a function of executing processing of inputting information in accordance with an operation by the first competitor B1 or the like, and processing of inputting information from another device.

For example, the terminal output unit 112 has a function of executing processing of outputting output target information in a predetermined mode, and processing of outputting information to another device.

Here, as the processing of outputting the output target information in a predetermined mode, for example, processing of displaying display output target information on a screen may be executed, or processing of outputting sound, vibration, light, or the like may be executed.

The terminal communication unit 113 communicates with another device. The communication is, for example, wireless communication. In the present embodiment, the terminal communication unit 113 communicates with, for example, the information processing device 11. This communication may be performed via, for example, a base station apparatus of a predetermined wireless communication system and the like.

The terminal reception unit 131 has a function of receiving information transmitted from the other device.

The terminal transmission unit 132 has a function of transmitting information to the other device.

Furthermore, while in the present embodiment, the terminal communication unit 113 is illustrated separately from the terminal input unit 111 and the terminal output unit 112, the function of the terminal reception unit 131 may be included in the function of the terminal input unit 111 or the function of the terminal transmission unit 132 may be included in the function of the terminal output unit 112, for example.

The terminal storage unit 114 stores information.

The terminal storage unit 114 may store various types of information.

The GPS unit 115 has a function of receiving a signal transmitted from the GPS satellite 31.

For example, the function of the GPS unit 115 may be included in the function of the terminal reception unit 131 or the function of the terminal input unit 111.

For example, position information and speed information are obtained based on a signal received by the GPS unit 115.

For example, the position information and the speed information may be regarded as the position information and the speed information of the first terminal device A1 including GPS unit 115, and may be regarded as the position information and the speed information of the first competitor B1 who possesses the first terminal device A1.

While a case where a GPS satellite system is used is described in the present embodiment, the present invention is not limited thereto, and another satellite system may be used. For example, a satellite system such as BeiDou, GLONASS, Galileo, or QZSs may be used.

Note that GPS, BeiDou, GLONASS, and Galileo are satellite systems of Global Navigation Satellite System (GNSS).

The biometric information detection unit 116 has a function of detecting biometric information.

In the present embodiment, the biometric information detection unit 116 of the first terminal device A1 detects biometric information of the first competitor B1 who possesses the first terminal device A1.

Similarly, the first terminal device A1 to the N-th terminal device AN respectively detect biometric information related to the first competitor B1 to the N-th competitor BN.

Here, as the biometric information, various pieces of information related to a living body may be used, and for example, any one or more pieces of information including a pulse, a heart rate, a SpO2, a body temperature, a blood pressure, and the like may be used.

In addition, the timing at which the biometric information is detected is not particularly limited, and may be, for example, a timing at a regular time interval or another predetermined timing.

The terminal control unit 117 executes various types of processing and control.

In the present embodiment, the first terminal device A1 is configured by using a computer.

The terminal control unit 117 includes a processor such as a central processing unit (CPU), and causes this processor to execute a predetermined program to perform various types of processing and control.

This program may be stored in the terminal storage unit 114, for example.

Here, in the present embodiment, the GPS unit 115 or the terminal control unit 117 acquires the position information and the speed information based on the signal received by the GPS unit 115, and the terminal transmission unit 132 transmits the position information and the speed information to the information processing device 11.

The timing at which the position information and the speed information are acquired is not particularly limited. For example, a timing at a regular time interval may be used, or another predetermined timing may be used.

The timing at which the position information and the speed information are transmitted to the information processing device 11 is not particularly limited. For example, a timing at a regular time interval may be used, or another predetermined timing may be used.

The timing at which the position information and the speed information are acquired and the timing at which the position information and the speed information are transmitted to the information processing device 11 may be, for example, synchronized with each other or may be independent of each other.

In the present embodiment, the biometric information detection unit 116 or the terminal control unit 117 transmits the biometric information detected by the biometric information detection unit 116 to the information processing device 11 via the terminal transmission unit 132.

The timing at which the biometric information is detected is not particularly limited. For example, a timing at a regular time interval may be used, or another predetermined timing may be used.

The timing at which the biometric information is transmitted to the information processing device 11 is not particularly limited. For example, a timing at a regular time interval may be used, or another predetermined timing may be used.

In addition, the timing at which the biometric information is detected and the timing at which the biometric information is transmitted to the information processing device 11 may be, for example, synchronized with each other or may be independent of each other.

In a configuration in which both the position information and the speed information and the biometric information are used, for example, the acquisition timing of the position information and the speed information and the detection timing of the biometric information may be synchronized with each other or may be independent of each other.

In such a configuration, for example, the transmission timing of the position information and the speed information and the transmission timing of the biometric information may be synchronized with each other or may be independent of each other. As a specific example, the position information, the speed information, and the biometric information may be collectively transmitted from the first terminal device A1 to the information processing device 11.

Here, each of the first terminal device A1 to the N-th terminal device AN may be, for example, a smartphone, or may be a dedicated device including the GPS unit 115 and the biometric information detection unit 116. The dedicated device may be, for example, a wearable terminal.

In the present embodiment, for convenience of description, a case where the first terminal device A1 to the N-th terminal device AN include the GPS unit 115 and the biometric information detection unit 116 is described as an example. However, as another example, in a configuration in which biometric information is not used, the first terminal device A1 to the N-th terminal device AN may not have the function of the biometric information detection unit 116.

In addition, the configuration example of the functional blocks illustrated in FIG. 2 is an example for description and is not limiting. Thus, other configurations may be used.

For example, the functions of the first terminal device A1 may be distributed to two or more separate devices.

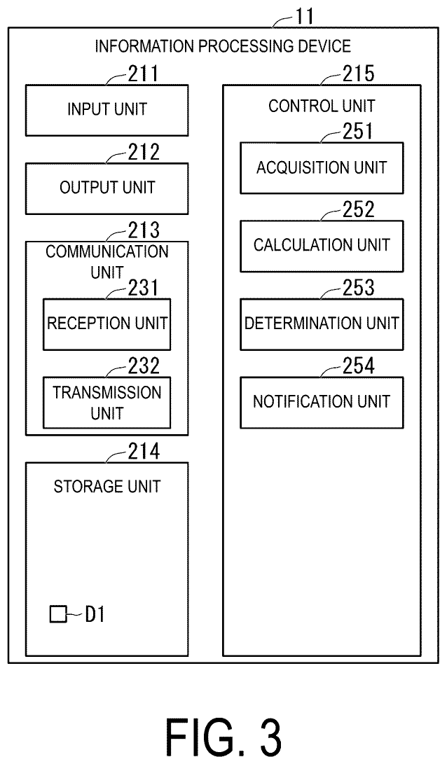

FIG. 3 is a diagram illustrating an example of a schematic functional block of the information processing device 11 according to the embodiment.

The information processing device 11 includes an input unit 211, an output unit 212, a communication unit 213, a storage unit 214, and a control unit 215.

The communication unit 213 includes a reception unit 231 and a transmission unit 232.

The control unit 215 includes an acquisition unit 251, a calculation unit 252, a determination unit 253, and a notification unit 254.

For example, the input unit 211 has a function of executing processing of inputting information in accordance with an operation of an operator operating the information processing device 11 or the like, and processing of inputting information from another device. For example, the output unit 212 has a function of executing processing of outputting output target information in a predetermined mode, and processing of outputting information to another device.

Here, as the processing of outputting the output target information in a predetermined mode, for example, processing of displaying display output target information on a screen may be executed, or processing of outputting sound, vibration, light, or the like may be executed.

The communication unit 213 communicates with another device. The communication is, for example, wireless communication. In the present embodiment, the communication unit 213 communicates with each of the first terminal device A1 to the N-th terminal device AN, for example. This communication may be performed via, for example, a base station apparatus of a predetermined wireless communication system and the like.

The reception unit 231 has a function of receiving information transmitted from the other device.

The transmission unit 232 has a function of transmitting information to the other device.

Furthermore, while in the present embodiment, the communication unit 213 is illustrated separately from the input unit 211 and the output unit 212, the function of the reception unit 231 may be included in the function of the input unit 211 or the function of the transmission unit 232 may be included in the function of the output unit 212, for example.

The storage unit 214 stores information.

The storage unit 214 may store various types of information.

In the present embodiment, the storage unit 214 stores course information D1.

The course information D1 is information of the course of the competition partitioned by the first competitor B1 to the N-th competitor BN, and may be, for example, information including the latitude and the longitude of the course or may be information including the altitude of the course.

Note that, for example, a configuration may be employed in which the course information D1 that is information including the latitude and longitude of a course and map information that is information including the altitude of a region including the course are stored in the storage unit 214, and the altitude of the course is identified based on the course information D1 and the map information. As another example, a method of identifying altitude information using signals from a satellite system such as a GPS may be used.

The control unit 215 executes various types of processing and also performs control.

In the present embodiment, the information processing device 11 is configured by using a computer.

The control unit 215 includes a processor such as a CPU, and causes this processor to execute a predetermined program to perform various types of processing and control.

This program may be stored in the storage unit 214, for example.

The acquisition unit 251 has a function of acquiring information necessary for processing.

For example, the acquisition unit 251 may acquire one or more of information input by the input unit 211, information received by the reception unit 231, and information stored in the storage unit 214.

In the present embodiment, for example, the acquisition unit 251 acquires the position information and the speed information for each of the first terminal device A1 to the N-th terminal device AN, and further acquires the biometric information if necessary.

Note that the acquisition unit 251 may further acquire other types of information.

The calculation unit 252 has a function of calculating predetermined information.

The calculation unit 252 calculates predetermined information using, for example, the information acquired by the acquisition unit 251.

In the present embodiment, the calculation unit 252 calculates, for example, information that is referred to for making a determination regarding a rank change among the first competitor B1 to the N-th competitor BN in the competition.

The determination unit 253 has a function of making a predetermined determination.

For example, the determination unit 253 may make a predetermined determination based on the information calculated by the calculation unit 252.

For example, the determination unit 253 may make the predetermined determination based on the information acquired by the acquisition unit 251, or may make the predetermined determination based on the information calculated by the calculation unit 252 and the information acquired by the acquisition unit 251.

In the present embodiment, the determination unit 253 makes a determination regarding the rank change among the first competitor B1 to the N-th competitor BN in the competition, for example.

The notification unit 254 has a function of issuing a predetermined notification.

In the present embodiment, the notification unit 254 notifies the notification destination device 21 of notification target information by transmitting the information to the notification destination device 21 via the transmission unit 232.

As another example, the notification unit 254 may issue the notification by displaying and outputting the notification target information by the output unit 212 and the like. In this case, for example, the notification destination device 21 may not be provided in the information processing system 1.

In the present embodiment, the notification unit 254 issues a notification regarding the rank change among the first competitor B1 to the N-th competitor BN in the competition, for example.

Here, the information processing device 11 may be, for example, a server device, a smartphone, or another computer.

In addition, the configuration example of the functional blocks illustrated in FIG. 3 is an example for description and is not limiting. Thus, other configurations may be used.

For example, the functions of the information processing device 11 may be distributed to two or more separate devices.

The notification destination device 21 may be any device, for example, a smartphone or another computer.

Although one notification destination device 21 is illustrated in the example of FIG. 1, a plurality of notification destination devices including the notification destination device 21 may be present, for example.

In addition, although the notification destination device 21 is illustrated as a device different from the first terminal device A1 to the N-th terminal device AN in the example of FIG. 1, a part or all of one or more of the first terminal device A1 to the N-th terminal device AN may be used as a notification destination device, for example.

As another example, notification may be issued only in the information processing device 11, and in this case, the notification destination device 21 is not provided.

As another example, notification may be issued in the information processing device 11 and also to the notification destination device 21.

Now a description will be given on the GPS unit 115 included in the first terminal device A1.

The first terminal device A1 including the GPS unit 115 has a function as a GPS-reception terminal and has a function as a position and speed measurement terminal.

The GPS unit 115 is provided to the first competitor B1 by attachment or the like, acquires the position of the first competitor B1 in response to a signal from the GPS satellite 31, and along with the position measurement, acquires the speed information of the first competitor B1. The position may be identified using latitude and longitude coordinates, for example.

The GPS unit 115 or the terminal control unit 117 transmits the position information and the speed information acquired by the GPS unit 115 to the information processing device 11 via the terminal transmission unit 132.

The GPS unit 115 measures the position at a predetermined time interval. The time interval is a preset time interval and may be, for example, 1.0 [sec].

The time interval is not limited to 1.0 [sec] and may be set to be longer than 1.0 [sec], such as 5.0 [sec], 10 [sec], or 1 [min]. In this case, the number of times the measurement is performed can be reduced, and thus the GPS unit 115 and the first terminal device A1 can operate for a longer period of time.

The time interval may be set to be shorter than 1.0 [sec]. By setting the time interval to be shorter, it is possible to increase the number of times the position information of the first competitor B1 is acquired.

Furthermore, the GPS unit 115 or the terminal control unit 117 can also calculate the speed of the first competitor B1 based on the true Doppler value calculated when the position measurement is performed.

The position information measured by the GPS unit 115 and the calculated speed information may be stored in the terminal storage unit 114, for example.

Further, the GPS unit 115 or the terminal control unit 117 transmits the position information and the speed information to the information processing device 11 at a predetermined time interval.

The time interval is a preset time interval, and is, for example, 1 [min].

Note that the time interval is not limited to 1 [min] and may be set to be longer than 1 [min], such as 2 [min] or 5 [min], as necessary. In this case, the number of times the transmission is performed can be reduced, and thus the GPS unit 115 and the first terminal device A1 can operate for a longer period of time.

The time interval may be set to be shorter than 1 [min]. By setting the time interval shorter, position measurement can be performed at a shorter time interval, and thus the position and the speed of the first competitor B1 can be recognized as needed.

Here, when transmitting the position information to the information processing device 11 at a time interval of 1 [min], for example, the first terminal device A1 including the GPS unit 115 may be configured to transmit all 60 pieces of position information measured every 1.0 [sec] in the time interval and calculated speed information, may be configured to transmit only the latest position information and speed information among the 60 pieces of position information and speed information, or may be configured to transmit another type of information such as a mean value of the 60 pieces of position information and speed information.

Next, an operation of the information processing device 11 will be described.

The information processing device 11 manages the position and rank of each competitor in the course based on the position information of the first competitor B1 to the N-th competitor BN transmitted from the first terminal device A1 to the N-th terminal device AN.

The information processing device 11 calculates information for determining whether the ranks are expected to change based on the position information and the speed information received from the first terminal device A1 to the N-th terminal device AN, and issues a predetermined notification when it is determined that the ranks are expected to change.

In the present embodiment, such calculation is performed by the calculation unit 252, such determination is performed by the determination unit 253, and such notification is issued by the notification unit 254. The information necessary for such calculation, determination, and notification is acquired by the acquisition unit 251.

In the information processing device 11, the reception unit 231 receives the position information and the speed information of the first competitor B1 to the N-th competitor BN transmitted from the first terminal device A1 to the N-th terminal device AN.

In the information processing device 11, before the start of the competition, the control unit 215 associates identification information of the first competitor B1 to the N-th competitor BN respectively with identification information of the first terminal device A1 to the N-th terminal device AN respectively attached to the first competitor B1 to the N-th competitor BN, and stores the resultant association information in the storage unit 214. The association may also be referred to as linking, matching, and the like, for example.

In the information processing device 11, the control unit 215 identifies the first competitor B1 to the N-th competitor BN set in advance respectively from the identification information of the first terminal device A1 to the N-th terminal device AN transmitting the position information and the speed information, and uses the received position information and speed information as the position information and the speed information of the identified competitor.

Here, the identification information of each of the first competitor B1 to the N-th competitor BN may be, for example, one or more pieces of information among individual information including names, ages, heights, weights, and the like, an e-mail address or a phone number used when applying for the competition, a login ID used in a form for applying for the competition, and the like, or may be a number assigned to each competitor.

The identification information of each of the first terminal device A1 to the N-th terminal device AN may be, for example, serial numbers of the terminals or numbers assigned at the time of the competition and the like.

In the information processing device 11, the course information D1 of the competition is stored in order to manage the position of the competitor in the course, for example.

The course information D1 includes, for example, information in which latitude and longitude coordinates and a distance from the start point are associated with each other.

In the information processing device 11, the calculation unit 252 calculates the position of each of the first competitor B1 to the N-th competitor BN in the course based on the latitude and longitude coordinates included in the position information of the first competitor B1 to the N-th competitor BN transmitted from the first terminal device A1 to the N-th terminal device AN, and the latitude and longitude coordinates included in the course information D1.

The position corresponds to, for example, a distance from the start point in the course.

In the information processing device 11, the determination unit 253 determines the rank of each competitor based on the position of each competitor in the course, and specifically, assigns the rank to each competitor in the order from the competitor at a position farthest from the start point to the competitor at a position closest to the start point. Thus, the competitor at the position farthest from the start point has the highest rank, and the competitor at the position closest to the start point has the lowest rank.

In this example, a case is described where the rank of each competitor is determined based on the start point. However, as another example, a mode may be employed in which the rank of each competitor may be determined based on the goal point. Thus, the rank may be assigned to each competitor in the order from the competitor at a position closest to the goal point to the competitor at a position farthest from the goal point.

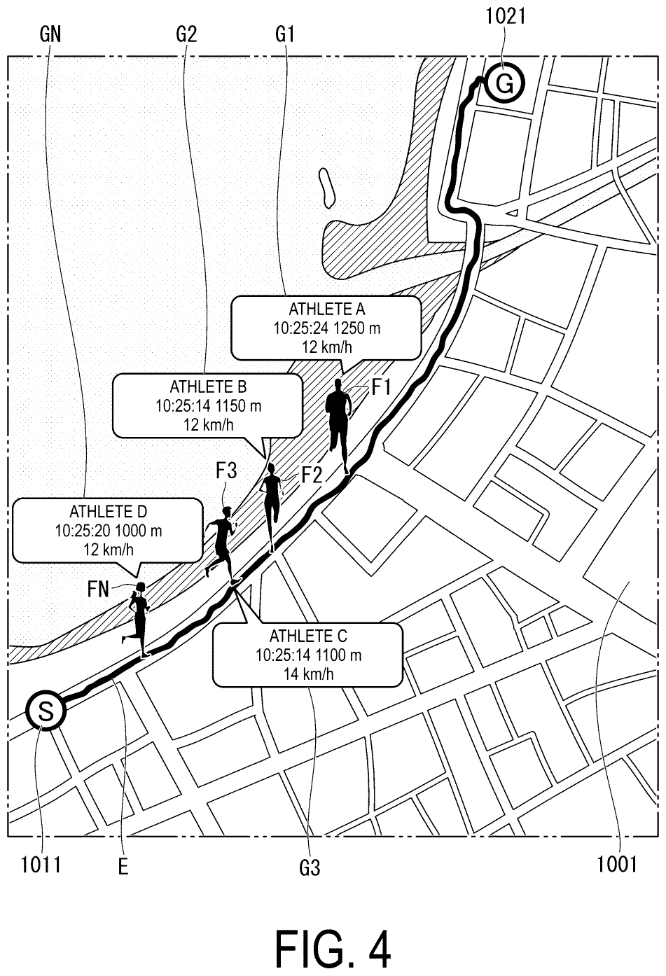

With reference to FIG. 4, an alert related to a change in the competitor's rank in the course will be described.

FIG. 4 is a diagram illustrating an example of information indicating the position of each competitor in a course according to the embodiment.

For example, the notification unit 254 of the information processing device 11 may provide the information as illustrated in FIG. 4 through displaying or the like, on the information processing device 11 itself or the notification destination device 21.

FIG. 4 illustrates a map 1001, a course E indicated on the map 1001, a start position 1011 of the course E, a goal position 1021 of the course E, a first place competitor F1 to an N-th place competitor FN who are competitors of respective ranks present on the course and indicated by predetermined marks, and first place competitor information G1 to N-th place competitor information GN that are information respectively corresponding to the first place competitor F1 to the N-th place competitor FN.

Here, the first place competitor F1 to the N-th place competitor FN represent the first competitor B1 to the N-th competitor BN in the order from the first place competitor to the N-th place competitor, respectively.

In the information processing device 11, the notification unit 254 generates the map 1001 based on, for example, the map information stored in the storage unit 214 or the map information acquired from the outside.

For example, the notification unit 254 generates the course E, the start position 1011 of the course E, and the goal position 1021 of the course E based on the course information D1 stored in the storage unit 214.

Here, the start position 1011 represents the start point of the competition, and the goal position 1021 represents the goal position of the competition.

In addition, for example, the determination unit 253 identifies the positions of the first place competitor F1 to the N-th place competitor FN based on the position information received from each of the first terminal device A1 to the N-th terminal device AN. Then, the notification unit 254 generates a mark representing the position of each of the first place competitor F1 to the N-th place competitor FN.

For example, the determination unit 253 identifies the competitor corresponding to each of the first place competitor F1 to the N-th place competitor FN based on the identification information received from each of the first terminal device A1 to the N-th terminal device AN. Then, the notification unit 254 generates the first place competitor information G1 to the N-th place competitor information GN that are information respectively related to the first place competitor F1 to the N-th place competitor FN.

In the information processing device 11, the calculation unit 252 calculates information for determining whether the ranks in the competition change, based on the position of each competitor in the course E of the competition and the speed information of each competitor. The determination unit 253 determines whether the ranks change based on the information. When it is determined that the ranks change, the notification unit 254 notifies the user of information related to the change in the ranks.

Now, a specific example will be given with the first place competitor F1 referred to as “athlete A”, the second place competitor F2 referred to as “athlete B”, the third place competitor F3 referred to as “athlete C”, and the N-th place competitor FN referred to as “athlete D”. In this example, the N-th place competitor FN is a competitor who is in the N-th place, and is the fourth place competitor when N=4, for example.

In the information processing device 11, the calculation unit 252 recognizes the position of each of the competitors, that is, the athlete A to the athlete D in the course E and makes comparison regarding the ranks.

In the example of FIG. 4, the athlete A is at a location 1250 [m] from the start point, the athlete B is at a location 1150 [m] from the start point, the athlete C is at a location 1100 [m] from the start point, and the athlete D is at a location 1000 [m] from the start point.

Here, as the distance from the start point, for example, a distance along a road from the start point to the goal point is used.

In this case, in the information processing device 11, the determination unit 253 determines that the athlete A farthest away from the start point is in the first place, the athlete B therebehind is in the second place, and the athlete C therebehind is in the third place. In addition, in the information processing device 11, the determination unit 253 determines that the athlete D is in the N-th place. When N=4, the athlete D is in the fourth place.

In the information processing device 11, the calculation unit 252 calculates the distance difference between the ranks from the position information of the respective athletes. In the example of FIG. 4, the distance difference between the first place and the second place is 100 [m], the distance difference between the second place and the third place is 50 [m], and the distance difference between the third place and the fourth place is 100 [m].

Next, in the information processing device 11, the calculation unit 252 recognizes the speed of each of competitors, that is, the athlete A to the athlete D in the course E and makes comparison regarding the ranks. In the present embodiment, the speed information is transmitted together with the position information from the first terminal device A1 to the N-th terminal device AN to the information processing device 11.

In the example illustrated in FIG. 4, the speed of the athlete A is 12 [km/h], the speed of the athlete B is 12 [km/h], the speed of the athlete C is 14 [km/h], and the speed of the athlete D is 12 [km/h].

In the information processing device 11, the determination unit 253 determines that the ranks are expected to change between the athlete B, who is the second place competitor F2, and the athlete C, who is the third place competitor F3, that is, between the ranks of the second place and the third place. That is, since the speed of the athlete C is higher than the speed of the athlete B, it is assumed that 50 [m], which is the distance difference between the athlete B and the athlete C, is reduced. Thus, it is expected that rank swapping occurs between the second place and the third place. In this case, the determination unit 253 determines that the distance difference is reduced by about 33.3 [m] (=2 [km]/60) per minute, based on the speed difference between the athlete B and the athlete C.

In the information processing device 11, when the determination regarding the rank change is made as described above, the notification unit 254 issues a notification of information related to the rank change.

In the information processing device 11, various conditions may be used as a condition for determining whether a change in rank occurs among the competitors based on the distance difference and the speed difference among the competitors.

In this example, it is determined whether a change in rank occurs between consecutive ranks such as between the first place and the second place or between the second place and the third place, for example. However, as another example, it may be determined whether a change in rank occurs between non-consecutive ranks such as between the first place and the third place, between the first place and the fourth place, or between the second place and the fourth place.

The content of the notification regarding the rank change will be described.

The content of the notification may be, for example, at least one of pieces of information such as that indicating that the ranks change, that indicating an expected time it takes for the rank change to occur including minutes until the rank change, and that indicating an expected distance, that is, an approximate location from the start point where the rank change occurs.

For example, instead of issuing the notification to the notification destination device 21 or along with issuing the notification to the notification destination device 21, the notification unit 254 may issue one or more of notification by video output by a display unit provided in the information processing device 11, notification by sound from a sound output unit provided in the information processing device 11, and the like. In the present embodiment, the display unit and the sound output unit are included in, for example, the output unit 212.

In addition, when the content of the notification regarding the rank change is issued by display by the display unit, for example, the notification unit 254 may perform one or more of changing colors to be displayed, highlighting, and the like with respect to the display information regarding the competitors involved in the rank change. The display information may be, for example, one or more of a mark representing the competitor, characters identifying the competitor, characters representing the position, distance, speed, time, and the like of the competitor, and the like. As a specific example, the notification unit 254 can perform a change in color of the mark or the character, highlighting of the mark or the character, or the like.

The timing of the notification regarding the rank change will be described.

The timing of the notification may be, for example, a calculated timing of the occurrence of the rank change, or may be another predetermined timing.

The predetermined timing may be, for example, a timing at which a change in rank occurs by the next time the information processing device 11 acquires the position information transmitted from the terminal device at a predetermined time interval.

For example, a case where communication timing between each of the first terminal device A1 to the N-th terminal device AN and the information processing device 11 is timing at which communication is performed at a time interval of 1 [min] is used as an example. In addition, a case where the distance difference between the second place competitor F2 and the third place competitor F3 is 50 [m] and it is calculated that the distance difference is reduced by 34 [m] per minute from the speed difference between the second place competitor F2 and the third place competitor F3 is used as an example. In this case, for example, since no rank change occurs between the second place competitor F2 and the third place competitor F3 by the next communication, the notification unit 254 does not issue the notification. Thereafter, if the condition of the speed difference remains to be the same at the time of the next communication, the notification unit 254 issues the notification because the rank change occurs between the second place competitor F2 and the third place competitor F3 by the next communication.

As described above, in the information processing device 11, for example, even in a period in which the first terminal device A1 to the N-th terminal device AN and the information processing device 11 do not communicate with each other, it is possible to predict a change in rank in the competition.

In addition, in the information processing device 11, for example, the calculation unit 252 may calculate information for predicting whether the rank change occurs using the altitude information of the course E.

For example, the altitude information may be included in the course information D1 or may be included in the map information.

For example, based on the altitude information of the position where the third competitor F3 is located and the altitude information of the position where the second competitor F2 is located, it may be determined whether the second competitor F2 is on uphill or downhill with respect to the position of the third competitor F3, and the determination result may be reflected on the reduction in the distance difference between the second place competitor F2 and the third place competitor F3. When the altitude of the position of the second place competitor F2 is higher than the altitude of the position of the third place competitor F3, it may be determined that the competitors are on an uphill, and when the altitude of the position of the third competitor F3 is higher than the altitude of the position of the second competitor F2, it may be determined that the competitors are on a downhill.

In addition, an average gradient from the position of the third place competitor F3 to the position of the second place competitor F2 may be calculated. When the average gradient from the position of the third place competitor F3 to the position of the second place competitor F2 is 10%, for example, the altitude increases by 5 [m] as a result of traveling 50 [m], which corresponds to the distance difference between the second place competitor F2 and the third place competitor F3. The speed on an uphill course portion is usually slower than the speed on a flat course portion. In order to take this into account, the average gradient may be reflected on the reduction in the distance difference between the second place competitor F2 and the third place competitor F3. For example, when the reduction in the distance difference on the uphill is calculated, 30.6 [m] as a result of reducing 34 [m] by 10% which is the average gradient may be set as the reduced distance difference on the uphill. This 34 [m] is the reduced distance difference on the flat state. Based on the distance difference between the second place competitor F2 and the third place competitor F3 thus calculated in consideration of the average gradient, it may be determined whether the rank swapping occurs between the second place competitor F2 and the third place competitor F3.

In addition, a mode may be employed in which if the average gradient between the position of the second competitor F2 and the position of the third competitor F3 exceeds a predetermined value, the information processing device 11 determines that the reason why the speed of the third place competitor F3 is higher than the speed of the second place competitor F2 is due to a temporary difference in altitude of a course portion, for example, and does not issue the notification. For example, the predetermined value may be 10%.

Here, in this example, the case where the predetermined timing at which the notification is issued is the timing at which the rank change occurs by the next communication is described. However, as another example, the predetermined timing at which the notification is issued may be the timing at which the rank change occurs by elapse of a predetermined time. The time may be any time such as 3 [min] or 5 [min], for example. With such a configuration, for example, the notification indicating the rank change can be more swiftly issued.

As another example, a timing under a condition satisfied when the distance between the competitors decreases to a predetermined distance or shorter may be used as the predetermined timing at which the notification is issued.

This predetermined distance or shorter may be 1.0 [km] or shorter, for example.

As a specific example, the notification unit 254 may issue the notification at a timing under a condition satisfied when the distance between the competitors decreases to 0 [m] within a predetermined time or shorter. For example, as the mode of the predetermined time or shorter, the following modes may be employed. Specifically, when one competitor catches up with another competitor in about 20 minutes, notification may be issued at a level of “possible”, when one competitor catches up with another competitor in about 10 minutes, notification may be issued at a level of “likely”, when one competitor catches up with another competitor in about 5 minutes, notification may be issued at a level of “caution”, when one competitor catches up with another competitor within one minute, the notification may be issued at a level of “group/proximal”.

Further, regarding the notification, a condition of the rank may be set, and for example, the notification may be issued under a condition satisfied when the rank change occurs among predetermined ranks.

As a specific example, the notification unit 254 may issue the notification under a condition satisfied when the rank change occurs involving the prize winner ranks in the competition.

Here, the ranks corresponding to the prize winner may be set for each competition, for example, or may be set for each event of the same competition. For example, the prize winners in a certain marathon event may be determined in advance to be the first to the third places, whereas the prize winners in another certain marathon event may be determined in advance to be the first to sixth places. Thus, the prize winners are not particularly limited.

As another specific example, the notification unit 254 may issue the notification under a condition satisfied when the rank change in the competition occurs involving the first place competitor.

By thus issuing the notification only for a certain rank, for example, it is not necessary to calculate a change in rank among all the competitors, and thus it is possible to reduce a processing load inside the information processing device 11.

Further, in this example, the change in rank between the third place competitor F3 and the second place competitor F2 with one rank higher is calculated. However, the present invention is not limited thereto. For example, a configuration may be employed in which whether the rank change involving the competitor with the highest rank, that is, the first place competitor F1 is calculated, and a notification indicating the result is issued.

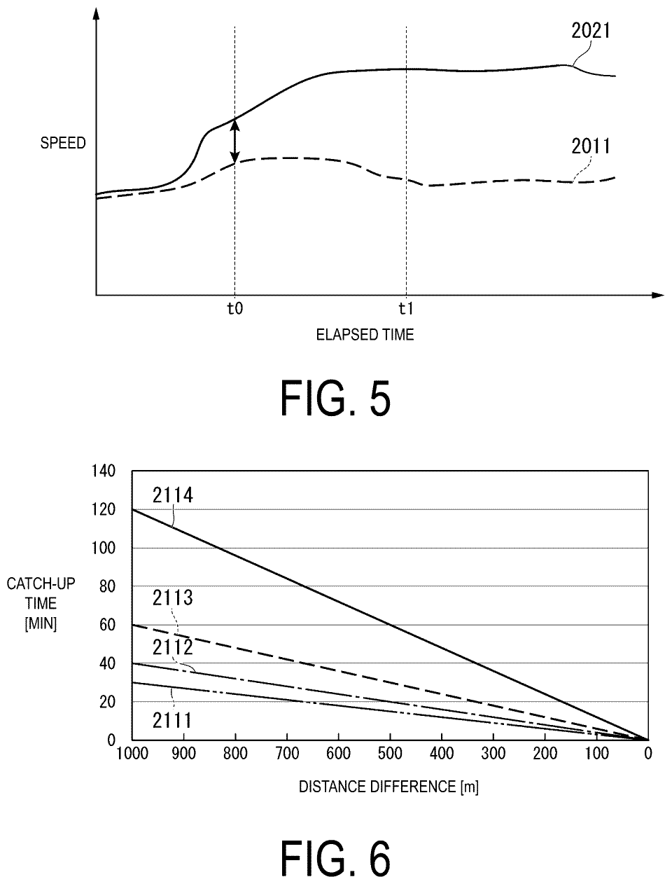

FIG. 5 is a diagram illustrating an example of speeds of two competitors and an alert notification timing according to the embodiment.

In the graph illustrated in FIG. 5, the horizontal axis represents time, and the vertical axis represents the speeds of the competitors.

The graph illustrates a speed A 2011 which is the speed of the athlete A changing over time and a speed B 2021 which is the speed of the athlete B over time.

Here, the elapsed time may be an elapsed time from any timing during the competition.

In the example of FIG. 5, when the rank of the athlete A is higher than the rank of the athlete B, the speed of the athlete B continues to be higher than the speed of the athlete A by a certain degree.

In the information processing device 11, the determination unit 253 determines that the athlete B is catching up with the athlete A at a constant pace, and determines that the rank change may occur between the athlete A and the athlete B. Then, the information processing device 11 issues an alert, for example, from a timing to at which the speed difference between the athlete B and the athlete A becomes equal to or exceeds a predetermined speed to a timing t1 after the time during which the difference is determined to be equal to or has exceeded the predetermined speed continues for a predetermined period. The predetermined speed difference is 100 [m]/min, and the predetermined time is, for example, 10 minutes.

It should be noted that the example of FIG. 5 is an example for description, and this example is not limiting, and various modes may be used.

In the information processing device 11, an average speed in a predetermined period may be used as the speed of each competitor. As the average speed, for example, a result of a moving average in the predetermined period may be used.

When the competition is marathon or the like, the average speed of competitors who are expected to be the prize winners may be recognized.

As a specific example, when the average speed is 18 [km/h] in marathon, the marathon finish time is 2 hours and 20 minutes. When the average speed is 20 [km/h] in the marathon, the marathon finish time is 2 hours and 6 minutes, which is the world record.

FIG. 6 is a diagram illustrating an example of a relationship between a distance difference and a catch-up time for each average speed difference according to the embodiment.

In the graph illustrated in FIG. 6, the horizontal axis represents the distance difference [m] between two competitors, and the vertical axis represents the time [minutes] required for a competitor to catch up with a competitor in front of him/her.

The graph illustrates a first characteristic 2111 when the average speed difference between two competitors is 2 [km/h], a second characteristic 2112 when the average speed difference between two competitors is 1.5 [km/h], a third characteristic 2113 when the average speed difference between two competitors is 1 [km/h], and a fourth characteristic 2114 when the average speed difference between two competitors is 0.5 [km/h].

As in the example of FIG. 6, from the average speed difference and the distance difference between two competitors, it is possible to predict how long it takes for a competitor to catch up with a competitor in front of him/her.

Further, for the notification, a condition related to a location may be set.

As a specific example, in the information processing device 11, within 1 [km] from the goal point, the calculation unit 252 calculates the speed necessary for the catching up, from the average speed difference among the competitors using the catch-up time and the distance to the goal, and adds the calculated speed. When the speed as a result of the addition is equal to or higher than the result obtained by adding 1 [km/h] to the average speed of the athlete up to the current point continues for one minute or more, it is determined that the competitor cannot catch up, and the notification unit 254 may not issue the notification indicating the rank change.

Next, a case where the biometric information of the competitor is used will be described.

In the present embodiment, the biometric information of the competitor may be used, and in this case, a detection result by the biometric information detection unit 116 illustrated in FIG. 2 is used.

When the biometric information of the competitor is not used, for example, the biometric information detection unit 116 may not be provided in the first terminal device A1.

In each of the first terminal device A1 to the N-th terminal device AN, the biometric information detection unit 116 detects and acquires biometric information of each of the first competitor B1 to the N-th competitor BN. In each of the first terminal device A1 to the N-th terminal device AN, the biometric information detection unit 116 or the terminal control unit 117 transmits the acquired biometric information to the information processing device 11.

In the information processing device 11, the calculation unit 252 calculates information for determining whether the rank change occurs, based on the received biometric information. In this case, for example, the calculation unit 252 may calculate information for determining whether the rank change occurs using the biometric information of each competitor together with the position information and the speed information of each competitor.

Each of the first terminal device A1 to the N-th terminal device AN may be, for example, a wristband-type terminal attached to a competitor's arm or the like. In this case, the biometric information detection unit 116 can acquire, for example, pulse information as the biometric information of the competitor, who is a target.

Here, the time interval at which the biometric information is acquired by the biometric information detection unit 116 may be, for example, the same as that for the timing at which positioning is performed, or may be that for a different timing.

Alternatively, for example, a configuration in which the biometric information is constantly detected by the biometric information detection unit 116 may be employed.

For example, the first terminal device A1 to the N-th terminal device AN may detect the exercise intensity of the first competitor B1 to the N-th competitor BN, respectively, from the biometric information acquired by the biometric information detection unit 116, and transmit the detected exercise intensity to the information processing device 11 together with the position information and the speed information.

Here, the exercise intensity of the competitor may be determined based on, for example, the pulse rate or the heart rate of the competitor.

Further, the exercise intensity of the competitor may be determined using the age of the competitor. In this case, for example, the age of the competitor may be set in advance in the terminal device of the competitor.

The information processing device 11 acquires the exercise intensities of the first competitor B1 to the N-th competitor BN received from the first terminal device A1 to the N-th terminal device AN.

Then, in the information processing device 11, the determination unit 253 may determine whether the rank change occurs based on the acquired exercise intensities.

For example, when the exercise intensity of a competitor is a predetermined value or more, the determination unit 253 determines that a huge load is imposed on the competitor, and determines that the speed received together with the exercise intensity of the athlete is unmaintainable. In this case, the determination unit 253 determines that the rank change would not occur, and notification regarding the rank change is not issued.

For example, the information processing device 11 determines that the exercise intensity is high when the estimated maximum heart rate is in a predetermined range.

The estimated maximum heart rate is a heart rate corresponding to the age of the competitor. For example, the maximum heart rate may be a value obtained by subtracting the age of the competitor from 220.

The predetermined range is, for example, 91 to 100%. This is one of ranges, of the heart rates, in which the exercise intensity is recognized to be high. Of the ranges of the heart rates, a range lower than 60% of the maximum heart rate corresponds to a low exercise intensity, a range of 618 to 70% of the maximum heart rate corresponds to a slightly low exercise intensity, a range of 71% to 80% of the maximum heart rate corresponds to a normal exercise intensity, a range of 81% to 90% of the maximum heart rate corresponds to a slightly high exercise intensity, and a range of 91% to 100% of the maximum heart rate corresponds to a high exercise intensity. Although the range of 91% to 100% is set as the predetermined range, the predetermined range is not limited thereto and 81% or more may be set as the predetermined range.

In general, the exercise intensity at 91 to 100% can be maintained for 900 to 1000 seconds, but it is often difficult to maintain the exercise intensity beyond that. A state after the intensity is thus maintained can be determined to be a fatigued state.

For example, in the information processing device 11, the determination unit 253 may determine whether or not the rank change occurs from the speed corresponding to 91 to 100%, and as a result, determine that the rank change occurs when the timing at which the rank change occurs is within 1000 seconds, and determine that no rank change occurs when the timing at which the rank change occurs exceeds 1000 seconds.

Note that each numerical value in this example is an example for description, and various modes may be employed without being limited thereto.

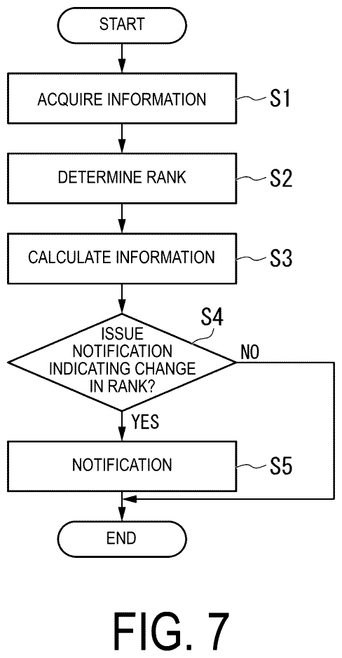

FIG. 7 is a diagram illustrating an example of a procedure of processing executed in the information processing device 11 according to the embodiment.

In the processing in step S1, the acquisition unit 251 in the information processing device 11 acquires predetermined information. Then, the processing proceeds to step S2.

The predetermined information includes the position information and the speed information of each competitor.

Further, the predetermined information may include the altitude information of each competitor.

The predetermined information may include the biometric information of each competitor.

In addition, the predetermined information may include other information.

In the processing in step S2, in the information processing device 11, the determination unit 253 determines the rank of each competitor based on the course information D1 and the position information of each competitor. Then, the processing proceeds to step S3.

In the processing in step S3, in the information processing device 11, the calculation unit 252 calculates information for determining whether the rank swapping is expected to occur among the competitors. Then, the processing proceeds to step S4.

In the processing in step S4, in the information processing device 11, the determination unit 253 determines whether the rank swapping is expected to occur among the competitors, and determines whether to issue notification of the rank change.

In the present embodiment, the determination unit 253 determines that the notification of the rank change is issued when it is determined that the rank swapping is expected to occur among the competitors, and determines that the notification is not issued in other cases.

Note that, as another example, there may be a case where the notification is not issued despite the fact that it is determined that the ranks of the competitors are expected to be swapped, or a case where a certain notification is issued despite the fact that it is determined that the ranks of the competitors are not expected to be swapped.

In the processing in step S4, in the information processing device 11, when the determination unit 253 determines that the notification of the rank change is to be issued, it is determined YES in step S4, and the processing proceeds to step S5.

On the other hand, in the processing in step S4, in the information processing device 11, when the determination unit 253 determines that the notification of the rank change is not to be issued, it is determined NO in step S4, and the processing of this flow ends.

In the processing in step S5, in the information processing device 11, the notification unit 254 issues the notification of information related to the rank change. Then, the processing in this flow ends.

Here, the information processing device 11 executes the processing in FIG. 7 at a regular time interval and the like, for example.

The information processing device 11 receives information transmitted from the first terminal device A1 to the N-th terminal device AN at a regular time interval, thereby accumulating the latest position information, speed information, and the like of each competitor.

As described above, with the information processing method and the information processing device 11 according to the present embodiment, it is possible to manage the position of each competitor participating in a competition and predict a change in rank in the competition.

For example, with the information processing method and the information processing device 11 according to the present embodiment, the position information and the speed information are received from the first terminal device A1 to the N-th terminal device AN that acquire the position information and the speed information of each competitor based on signals from satellites, and based on the received information, it is determined whether one competitor is likely to catch up with another competitor.

Accordingly, with the information processing method and the information processing device 11 according to the present embodiment, information related to a change in rank in a competition can be presented.

In the present embodiment, for example, in a competition such as marathon, a GPS tracker or the like is attached to each competitor, and the measurement result of the running distance and time of each competitor and the calculation result of the rank can be presented in real time during the competition. When the rank change among competitors is likely to occur, an alert regarding the rank change can be issued as a notification in real time.

As one configuration example, in the information processing method and the information processing device 11, the first position information and the first speed information are received from the first terminal device A1, which acquires the first position information and the first speed information based on signals from the satellite 31.

With the information processing method and the information processing device 11, second position information and second speed information are received from the second terminal device A2, which acquires the second position information and the second speed information based on signals from the satellite 31.

With the information processing method and the information processing device 11, in a course of a competition in which the first competitor B1 to which the first terminal device A1 is attached and the second competitor B2 to which the second terminal device A2 is attached participate, a distance difference between the first competitor B1 and the second competitor B2 is calculated based on the first position information and the second position information, and a speed difference between the first competitor B1 and the second competitor B2 is calculated based on the first speed information and the second speed information.

With the information processing method and the information processing device 11, based on the distance difference and the speed difference, a notification related to swapping of the rank of the first competitor B1 and the rank of the second competitor B2 in the competition is issued.

Therefore, with the information processing method and the information processing device 11, for example, it is possible to issue a notification of the information related to swapping of the ranks regarding whether the ranks of the competitors are swapped and the like. Here, a mode in which a terminal device is attached to a competitor is not particularly limited, and for example, a mode in which the terminal device is directly attached to a predetermined part of the body such as an arm or a leg of the competitor may be employed, or a mode in which the terminal device is substantially attached to the competitor by being stored in a pocket of cloth of the competitor may be employed.

As one configuration example, with the information processing method and the information processing device 11, a notification indicating a location in the course where the rank of the first competitor B1 and the rank of the second competitor B2 are swapped is issued.

Therefore, with the information processing method and the information processing device 11, for example, a notification not only indicating that the ranks of the competitors are swapped but also indicating the location at which the rank swapping occurs can be issued.

As one configuration example, with the information processing method and the information processing device 11, at least one of the rank of the first competitor B1 and the rank of the second competitor B2 is equal to or higher than the prize winner ranks in the competition.

Therefore, with the information processing method and the information processing device 11, the notification is issued when the rank swapping involves a prize winner, and for example, by narrowing down the conditions for issuing a notification, the processing load related to the notification can be reduced.

As one configuration example, with the information processing method and the information processing device 11, at least one of the rank of the first competitor B1 and the rank of the second competitor B2 is the first place in the competition.

Therefore, with the information processing method and the information processing device 11, the notification is issued when the rank swapping involves the first place, and for example, by narrowing down the conditions for issuing a notification, the processing load related to the notification can be reduced.

As one configuration example, with the information processing method and the information processing device 11, the altitude difference is calculated from the first altitude information of the first competitor B1 based on the course information D1 related to the course and the first position information and the second altitude information of the second competitor B2 based on the course information D1 and the second position information.

With the information processing method and the information processing device 11, swapping of the rank of the first competitor B1 and the rank of the second competitor B2 is determined according to the distance difference, the speed difference, and the altitude difference.

Therefore, with the information processing method and the information processing device 11, it is possible to determine whether the rank swapping occurs by using the altitude information, and for example, it is possible to accurately determine the rank swapping. As a specific example, such a configuration may be employed in a scene of marathon in which the first competitor B1 may be running uphill but the second competitor B2 has not reached the uphill yet.

As one configuration example, with the information processing method and the information processing device 11, the first biometric information of the first competitor B1 is received, and the second biometric information of the second competitor B2 is received.

With the information processing method and the information processing device 11, swapping of the rank of the first competitor B1 and the rank of the second competitor B2 is determined according to at least one of the first biometric information and the second biometric information, the distance difference, and the speed difference.

Therefore, with the information processing method and the information processing device 11, it is possible to make the determination related to the rank swapping based on the biometric information, and for example, it is possible to accurately determine the rank swapping.

As one configuration example, with the information processing method and the information processing device 11, it is determined whether the rank of the first competitor B1 is higher than the rank of the second competitor B2 in the competition and whether the second biometric information is equal to or less than a predetermined value. The notification is not issued when the second biometric information exceeds the predetermined value.

Therefore, with the information processing method and the information processing device 11, for example, it is determined whether the biometric information of the catching-up competitor, who is the competitor with the higher speed, is within a predetermined range, and if the biometric information is not within the predetermined range, it is considered that a huge load is imposed on the body of the catching-up competitor and the speed cannot be maintained, and thus it is determined that no swapping will occur. In this example, the second competitor B2 is the catching-up competitor.

Further, in this example, when the biometric information exceeds a predetermined value, it is considered that a huge load is imposed on the body.

In this example, the upper limit value of the predetermined range is a predetermined value. The lower limit value of the predetermined range may be arbitrarily set.

As one configuration example, with the information processing method and the information processing device 11, the predetermined value is a value corresponding to the age of the second competitor B2.

Therefore, with the information processing method and the information processing device 11, the predetermined range is a range within the index having the upper limit value corresponding to the age of the target. In this example, for example, it is possible to automatically set the lower limit value and the upper limit value, and it is possible to save time and effort for the target or the like to input these values.

As one configuration example, with the information processing method and the information processing device 11, the first position information and the first speed information are received from the first terminal device A1 and the second position information and the second speed information are received from the second terminal device A2 at a regular time interval.

With the information processing method and the information processing device 11, it is determined whether the rank of the first competitor and the rank of the second competitor in the competition are swapped after the latest reception of the first position information, the first speed information, the second position information, and the second speed information and before the next reception of the first position information, the first speed information, the second position information, and the second speed information.

Therefore, with the information processing method and the information processing device 11, it is possible to predict whether the rank swapping occurs by the next time the position information and speed information are received from the first terminal device A1 and the second terminal device A2. Thus, for example, the notification can be issued when the rank change occurs by update processing for the position information and the speed information.

As one configuration example, with the information processing method and the information processing device 11, it is determined whether the rank of the first competitor B1 and the rank of the second competitor B2 are swapped within a predetermined distance range.

Therefore, with the information processing method and the information processing device 11, it is possible to estimate whether the rank swapping occurs in the predetermined distance range. Thus, for example, it is possible to issue the notification when the ranks change in the predetermined distance range.

Here, the predetermined distance range may be, for example, a range from a position at which one of the first competitor B1 and the second competitor B2 is present to a predetermined distance ahead along the course, or a range of a predetermined distance ahead along the course from a starting point that is a position at a first distance ahead along the course from the position at which one of the first competitor B1 and the second competitor B2 is present.

A program for realizing the function of a given component in a given device described above may be recorded on a computer-readable recording medium, and the program may be read and executed by a computer system. The “computer system” as used herein is assumed to include hardware such as an operating system or peripheral devices. The “computer-readable recording medium” is a storage device such as a portable medium such as a flexible disk, a magneto-optical disk, a read only memory (ROM), a compact disc (CD)-ROM, and a hard disk built into a computer system. The “computer-readable recording medium” is assumed to include a medium that holds a program for a certain period of time, such as a volatile memory provided inside of a computer system serving as a server or a client when the program is transmitted via a network such as the Internet or a communication line such as a telephone line. The volatile memory may be a RAM. The recording medium may be a non-transitory recording medium.

The program described above may be transmitted from a computer system storing this program in a storage device or the like via a transmission medium or using transmission waves in a transmission medium to another computer system. The “transmission medium” from which the program is transmitted refers to a medium having a function of transmitting information, such as a network such as the Internet or a communication line such as a telephone line.

The program described above may be a program for realizing a part of the above-described functions. The program described above may be a so-called difference file, which can realize the above-described functions in combination with a program already recorded in the computer system. The difference file may be called a difference program.

The function of a given component in a given device described above may be realized by a processor. Each of the processes in the embodiment may be realized by a processor that operates based on information such as a program and a computer-readable recording medium that stores information such as a program. In the processor, the function of each unit may be realized by individual hardware, or the function of each unit may be realized by integrated hardware. The processor may include hardware, and the hardware may include at least one of a circuit for processing digital signals and a circuit for processing analog signals. The processor may be configured using one of or both of one or more circuit devices or one or more circuit elements mounted on a circuit board. For the circuit device, an integrated circuit (IC) or the like may be used, and for the circuit element, a resistor, a capacitor, or the like may be used.

The processor may be a CPU. However, the processor is not limited to the CPU, and it may be possible to use various processors such as a graphics processing unit (GPU) or a digital signal processor (DSP). The processor may be a hardware circuit using an application-specific integrated circuit (ASIC). The processor may be configured by a plurality of CPUs or may be configured by a hardware circuit including a plurality of ASICs. The processor may be configured by a combination of a plurality of CPUs and a hardware circuit including a plurality of ASICS. The processor may include one or more of an amplifier circuit, a filter circuit, and the like for processing analog signals.

These are detailed descriptions of the embodiment with reference to the drawings. However, the specific configurations are not limited to those of this embodiment, and include designs and the like without departing from the gist of the present disclosure.

### SUPPLEMENTARY NOTE

The following describes Configuration Example 1 to Configuration Example 11.

Note that a lower configuration example may or may not be applied to a higher configuration example.

In addition, a lower configuration example applicable to any one of two or more higher configuration examples may be applied to any configuration example of the two or more higher configuration examples. Furthermore, if there are two or more application examples, configuration examples lower than the lower configuration examples described above may be applied to any application example of the two or more application examples.

### Configuration Example 1

An information processing method comprising:
receiving first position information and first speed information from a first terminal device configured to acquire the first position information and the first speed information based on a signal from a satellite;
receiving second position information and second speed information from a second terminal device configured to acquire the second position information and the second speed information based on a signal from the satellite;
calculating for a course of a competition, participated by a first competitor to which the first terminal device is attached and a second competitor to which the second terminal device is attached, a distance difference between the first competitor and the second competitor based on the first position information and the second position information, and calculating a speed difference between the first competitor and the second competitor based on the first speed information and the second speed information; and
issuing a notification related to swapping between a rank of the first competitor and a rank of the second competitor in the competition, based on the distance difference and the speed difference.

### Configuration Example 2

The information processing method according to Configuration Example 1, comprising issuing a notification
indicating a location in the course at which the rank of the first competitor and the rank of the second competitor are swapped.

### Configuration Example 3

The information processing method according to Configuration Example 1 or Configuration Example 2, wherein
at least one of the rank of the first competitor and the rank of the second competitor is a rank equal to or higher than a rank of a prize winner in the competition.

### Configuration Example 4

The information processing method according to any one of Configuration Example 1 to Configuration Example 3, wherein
at least one of the rank of the first competitor and the rank of the second competitor is a first place in the competition.

### Configuration Example 5

The information processing method according to any one of Configuration Example 1 to Configuration Example 4, comprising:
calculating an altitude difference from first altitude information of the first competitor based on course information related to the course and the first position information and second altitude information of the second competitor based on the course information and the second position information; and
determining the swapping between the rank of the first competitor and the rank of the second competitor based on the distance difference, the speed difference, and the altitude difference.

### Configuration Example 6

The information processing method according to any one of Configuration Example 1 to Configuration Example 5, comprising:
receiving first biometric information of the first competitor;
receiving second biometric information of the second competitor; and
determining the swapping between the rank of the first competitor and the rank of the second competitor based on at least one of the first biometric information and the second biometric information, on the distance difference, and on the speed difference.

### Configuration Example 7

The information processing method according to Configuration Example 6, wherein
the rank of the first competitor in the competition is higher than the rank of the second competitor,
the method comprises determining whether the second biometric information is equal to or less than a predetermined value, and
the notification is not issued when the second biometric information exceeds the predetermined value.

### Configuration Example 8

The information processing method according to Configuration Example 7, wherein
the predetermined value is a value corresponding to an age of the second competitor.

### Configuration Example 9

The information processing method according to any one of Configuration Example 1 to Configuration Example 8, comprising:
receiving the first position information and the first speed information from the first terminal device and receiving the second position information and the second speed information from the second terminal device at a regular time interval; and
determining whether the rank of the first competitor and the rank of the second competitor in the competition are swapped after latest reception of the first position information, the first speed information, the second position information, and the second speed information and before next reception of the first position information, the first speed information, the second position information, and the second speed information.

### Configuration Example 10

The information processing method according to any one of Configuration Example 1 to Configuration Example 9, comprising determining whether the rank of the first competitor and the rank of the second competitor are swapped within a predetermined distance range.

It is also possible to provide an information processing device having a function of executing a process similar to the above-described information processing method.

### Configuration Example 11

An information processing device comprising:
a reception unit configured to receive first position information and first speed information from a first terminal device configured to acquire the first position information and the first speed information based on a signal from a satellite, and to receive second position information and second speed information from a second terminal device configured to acquire the second position information and the second speed information based on a signal from the satellite;
a storage unit configured to store course information related to a course of a competition, participated by a first competitor to which the first terminal device is attached and a second competitor to which the second terminal device is attached;
a determination unit configured to determine a rank of the first competitor and a rank of the second competitor, based on a position of the first competitor and a position of the second competitor;
a calculation unit configured to calculate a distance difference between the first competitor and the second competitor based on the first position information and the second position information, and to calculate a speed difference between the first competitor and the second competitor based on the first speed information and the second speed information; and
a notification unit configured to issue a notification related to swapping between the rank of the first competitor and the rank of the second competitor, based on the distance difference and the speed difference.

What is claimed is:

1. An information processing method comprising:
receiving first position information and first speed information from a first terminal device configured to acquire the first position information and the first speed information based on a signal from a satellite;
receiving second position information and second speed information from a second terminal device configured to acquire the second position information and the second speed information based on a signal from the satellite;
calculating for a course of a competition, participated by a first competitor to which the first terminal device is attached and a second competitor to which the second terminal device is attached, a distance difference between the first competitor and the second competitor based on the first position information and the second position information, and calculating a speed difference between the first competitor and the second competitor based on the first speed information and the second speed information; and
issuing a notification related to swapping between a rank of the first competitor and a rank of the second competitor in the competition, based on the distance difference and the speed difference.

2. The information processing method according to claim 1, comprising issuing a notification indicating a location in the course at which the rank of the first competitor and the rank of the second competitor are swapped.

3. The information processing method according to claim 1, wherein
at least one of the rank of the first competitor and the rank of the second competitor is a rank equal to or higher than a rank of a prize winner in the competition.

4. The information processing method according to claim 1, wherein
at least one of the rank of the first competitor and the rank of the second competitor is a first place in the competition.

5. The information processing method according to claim 1, comprising:
calculating an altitude difference from first altitude information of the first competitor based on course information related to the course and the first position information and second altitude information of the second competitor based on the course information and the second position information; and
determining the swapping between the rank of the first competitor and the rank of the second competitor based on the distance difference, the speed difference, and the altitude difference.

6. The information processing method according to claim 1, comprising:
receiving first biometric information of the first competitor;
receiving second biometric information of the second competitor; and
determining the swapping between the rank of the first competitor and the rank of the second competitor based on at least one of the first biometric information and the second biometric information, on the distance difference, and on the speed difference.

7. The information processing method according to claim 6, wherein
the rank of the first competitor in the competition is higher than the rank of the second competitor,
the method comprises determining whether the second biometric information is equal to or less than a predetermined value, and
the notification is not issued when the second biometric information exceeds the predetermined value.

8. The information processing method according to claim 7, wherein
the predetermined value is a value corresponding to an age of the second competitor.

9. The information processing method according to claim 1, comprising:
receiving the first position information and the first speed information from the first terminal device and receiving the second position information and the second speed information from the second terminal device at a regular time interval; and
determining whether the rank of the first competitor and the rank of the second competitor in the competition are swapped after latest reception of the first position information, the first speed information, the second position information, and the second speed information and before next reception of the first position information, the first speed information, the second position information, and the second speed information.

10. The information processing method according to claim 1, comprising determining whether the rank of the first competitor and the rank of the second competitor are swapped within a predetermined distance range.

11. An information processing device comprising:
a reception unit configured to receive first position information and first speed information from a first terminal device configured to acquire the first position information and the first speed information based on a signal from a satellite, and to receive second position information and second speed information from a second terminal device configured to acquire the second position information and the second speed information based on a signal from the satellite;
a storage unit configured to store course information related to a course of a competition, participated by a first competitor to which the first terminal device is attached and a second competitor to which the second terminal device is attached;
a determination unit configured to determine a rank of the first competitor and a rank of the second competitor, based on a position of the first competitor and a position of the second competitor;
a calculation unit configured to calculate a distance difference between the first competitor and the second competitor based on the first position information and the second position information, and to calculate a speed difference between the first competitor and the second competitor based on the first speed information and the second speed information; and
a notification unit configured to issue a notification related to swapping between the rank of the first competitor and the rank of the second competitor, based on the distance difference and the speed difference.
